(19) United States
(12) Patent Application Publication
(10) Pub. No.: US 2024/0219892 A1
(43) Pub. Date: Jul. 4, 2024

(54) Control Device for Machine Control and Sensor Data Evaluation

(71) Applicant: Pilz GmbH & Co. KG, Ostfildern (DE)

(72) Inventor: Dietmar Doettling, Ostfildern (DE)

(21) Appl. No.: 18/603,750

(22) Filed: Mar. 13, 2024

Related U.S. Application Data
(63) Continuation of application No. PCT/EP2022/074765, filed on Sep. 6, 2022.

(30) Foreign Application Priority Data
Sep. 14, 2021 (DE) 102021123762.9

(51) Int. Cl. G05B 19/4155

(52) U.S. Cl. CPC G05B 19/4155; G05B 2219/31229

(57) ABSTRACT

A control device for machine control and sensor data evaluation. The control device includes a first interface to basic and composite sensors for machine control, a second interface to sensors for sensor data evaluation, a central processing unit, and an operating system for executing user programs using the central processing unit. The user programs include at least a first user program and a second user program. The first user program is a user program for machine control that executes a control function on the basis of an evaluation of the basic and composite sensors. The second user program is a user program for sensor data evaluation that evaluates sensor data received via the second interface.

### CROSS-REFERENCE TO RELATED APPLICATIONS

This application is a continuation of PCT International Application No. PCT/EP2022/074765 filed Sep. 6, 2022, which claims priority to German Patent Application No. DE 10 2021 123 762.9 filed Sep. 14, 2021. The entire disclosures of the above applications are incorporated by reference.

### FIELD

The present disclosure relates to a control device for machine control and sensor data evaluation.

### BACKGROUND

Control devices (hereinafter also referred to as “controllers”) are generally known in the field of automation technology. Control devices control and regulate technical systems, machines or processes. Due to their flexibility and adaptability, programmable logic controllers (PLCs) have become established for complex or dynamically changing control and regulation tasks in process and automation technology. A simple programmable logic controller comprises at least one central processing component (with a main processor) and at least one input component and one output component.

Sensors are connected to the input component to detect a status of a technical system or machine to be controlled or a status of its surroundings. The processing component evaluates the sensor data acquired by the input component and generates control commands that are forwarded to the output component. The output component is connected to corresponding actuators that control the technical system or machine based on the control commands.

The sensors connected to the input component can be referred to as basic and composite sensors. Basic sensors are sensor devices that are used to measure a physical quantity and convert the physical quantity into an electrical quantity. Basics sensor can be proximity sensors or reflection light barriers, for example. A composite sensor is the combination of several basic sensors in one housing, for example a light grid. Basic and composite sensors therefore display a specific value or indicate a defined status (binary status). Basic and composite sensors known from automation technology are, for example, light scanners, light grids, proximity sensors, ultrasonic sensors, fill level sensors or similar devices.

In addition to basic and composite sensors, smart sensors are increasingly being used in automation technology. Smart sensors (sensor systems) can prepare and process measured variables themselves and provide complex data at network-compatible interfaces. Smart sensors can, for example, include object detection and identification and thus record complex processes in order to implement access and area monitoring systems. Smart sensors require correspondingly powerful evaluation equipment and applications that evaluate the complex sensor data and convert it into the input signals relevant for machine control.

Special evaluation units can be connected to several smart sensors via corresponding network interfaces in order to link the data from several sensors and provide an aggregated output signal (sensor data fusion). The sensor data evaluation of the smart sensors carried out by the dedicated evaluation unit is usually independent of the signals recorded by the basic and composite sensors of the machine control system. Rather, this data is only linked within the control device, which receives both the input signals from the basic/composite sensors and the aggregated output signals from the sensor data evaluation of the smart sensors. In this case, the aggregated output signals are generally treated by the control device like regular input signals indicating a specific status.

DE 10 2005 020 028 A1, for example, shows object detection by using several sensors. In DE 10 2005 020 028 A1, at least two sensors are networked via a data bus in order to forward an overall detection result (aggregated output signal) to a higher-level control device, which executes a machine control based on the detection.

DE 10 2010 007 520 B3 shows a safety controller with a large number of connections for sensors and a method for safe monitoring of a monitoring area with several sensors connected to the safety controller. The safety controller receives the sensor data from the connected various sensors, whereby all possibilities from the transmission of simple sensor data, such as a binary signal, to the transmission of the entire raw data of a complex sensor are conceivable. The sensor data received is converted by calculation into a common object detection signal, taking into account a configured weighting. The common object detection signal is output via a safety output of the safety controller.

DE 10 2019 116 664 A1 shows a system in which sensor data from several sensors is recorded and evaluated by an evaluation unit (master IO-Link) and the evaluated signal is provided to a machine controller (PLC).

### SUMMARY

It is an object to provide an improved control device which enables effective machine control while effectively recording and taking into account various sensor data from different sensors.

According to an aspect of the present disclosure, there is provided a control device for machine control and sensor data evaluation, comprising: a first interface to basic and composite sensors for machine control; a second interface to sensors for sensor data evaluation; a central processing unit; and an operating system for executing user programs using the central processing unit, wherein the user programs comprise at least a first user program and a second user program, and wherein the first user program is a user program for machine control which executes a control function on the basis of an evaluation of the basic and composite sensors, and wherein the second user program is a user program for sensor data evaluation which evaluates sensor data received via the second interface.

It is therefore an idea of the present disclosure to combine machine control and sensor data evaluation in one device. For this purpose, the control device has an operating system that allows the execution of various user programs. A first user program (hereinafter also referred to as a PLC application) is a standard control program that performs an automation task for machine control. The first user program, for example, works according to the familiar IPO (input-process-output) model, in which input states are first recorded and processed and then output states are set. The first user program is therefore a program that can normally be executed on a programmable logic controller.

In addition to the first user program, the operating system also executes a second user program that evaluates sensor data received via the second interface. In contrast to the first user program, the second user program is not a control program as such, but a data processing program that contains, for example, algorithms for signal processing or pattern recognition. The second user program is therefore not designed to directly control a machine which is to be controlled by the control device, but to process the sensor data in order to derive application-relevant or control-relevant information from it. The derived information can in turn be used by the first user program to directly control the machine.

A control device according to the present disclosure thus executes at least two user programs that perform different tasks and are fed from different input sources. The advantage of integration into one unit is that data from the control system (automation data) and sensor data from complex sensors (smart sensors) can be combined, exchanged, and compared without additional interfaces. This means that a uniform evaluation can be carried out without first having to combine the sensor data from the complex sensors into a (binary) status signal. A separate evaluation unit for the sensor data evaluation of complex sensors can therefore be dispensed with, including any costs for installation and commissioning.

It is also possible for the sensor data from the complex sensors to be evaluated taking into account the input signals from the basic and composite sensors received by the control device. In other words, sensor data fusion can take place not only between aggregated signals, but also at the level of raw sensor data. Thereby, sensor data fusion can be carried out at another level, for example at a pure data level, a feature level, and/or a decision level. This can significantly improve the quality of the evaluation. Furthermore, results can be achieved that would not be possible at all without data fusion at different levels.

More advantages of sensor data fusion are flexibility in application, increase in sensor detection capability and/or reliability, improvement in sensor measurement accuracy or enlargement of the field of view, resolution of ambiguities or occlusions, and saving on expensive sensors by using low-cost sensors whose signals are fused to form a complex evaluation signal.

As both user programs run on the same operating system, it is possible to use the operating system's facilities to enable data exchange between the two user programs. This makes it possible to carry out extended data evaluation in real time. Furthermore, data can be synchronized directly during evaluation.

Finally, it is possible to reuse already known, standardized sensors, actuators and communication using a control device according to the present disclosure and to combine them with data from complex sensors.

The control device according to the present disclosure thus combines machine control and sensor data evaluation in one unit (in a housing as a uniform device), whereby the two tasks (machine control/sensor data evaluation) are realized by separate user programs which are executed on a common operating system. Existing user programs for both machine control and sensor data evaluation can be reused. In this way, effective machine control can be realized comprehensively and efficiently.

In a further refinement, the second user program makes the evaluated sensor data available to the first user program, which can use the evaluated sensor data for machine control.

The first user program can therefore directly access the results of the sensor data evaluation determined by the second user program and use it for machine control. This makes machine control more efficient, comprehensive, and flexible.

In a further refinement, the operating system executes the first user program and the second user program in parallel.

The operating system is therefore configured for parallel execution of user programs. Parallel execution makes it possible for the two user programs to access data from the other program easily and without latency. Furthermore, a hardware structure for the efficient execution of parallel processes can be optimally utilized. For example, calculation pauses that typically occur in an IPO procedure during input and output processes can be utilized by executing the algorithms for sensor data evaluation. This makes the control device more effective overall.

In a further refinement, the first interface is an interface for I/O communication via a fieldbus, for instance, an IO-Link interface.

Basic and composite sensors can thus be connected to the control device in a known manner via the first interface. The control device can therefore make use of existing structures. This allows a control device according to the present disclosure to be integrated into an existing system by replacing the control device (or the processing unit) as such, but not the sensors or the modules via which the basic and composite sensors are connected to the control device. An existing sensor arrangement consisting of basic and composite sensors can therefore continue to be used without modification. Smart sensors, on the other hand, can be easily retrofitted to existing systems, with the actual control-relevant sensor technology remaining unchanged. IO-Link is a globally standardized IO technology for communicating with sensors and actuators in industrial environments.

In a further refinement, the first interface is a module of the control device and is coupled to the central processing unit via an internal bus connection.

Thereby, only the processing unit needs to be replaced in order to implement the new control device. Existing input modules (and/or output modules) can remain the same.

In a further refinement, the second interface is a real-time capable interface.

By receiving the sensor data via a real-time capable interface, the sensor data can be evaluated in real time and the evaluated sensor data can be linked to the first user program in real time. This makes it easy to implement even complex scenarios that require a combination of basic and network sensor data with data from smart sensors.

In a further refinement, the second interface is a standardized IP-based interface, for example an OPC-UA (Open Platform Communications Unified Architecture) interface.

IP-based interfaces allow the connection of a wide range of sensors (and other components) via a standardized interface and the exchange of a wide variety of data. The connectivity of the control device can thus be improved via such an interface so that it can also receive complex data in almost any quantity.

In a further refinement, the second interface is a wired (cable-based) and/or a wireless (radio-based) interface.

The control device is therefore not restricted to a specific type of data transmission but can acquire data from sensors via various connections. Thereby, sensors can be connected easily to the control device.

In a further refinement, the first user program and the second user program are connected to each other via an internal data interface.

Via an internal data interface, the first user program and the second user program can be linked with each other efficiently, quickly, robustly, and securely, wherein known mechanisms of common operating systems, such as inter-process communication (IPC), can be used for this purpose. Combining basic and composite sensors for machine control with smart sensors is therefore easy to implement (cross-level sensor data fusion).

In a further refinement, the control device has a working memory, and the operating system assigns a common memory area within the working memory to the first user program and the second user program.

By accessing a shared memory area, an internal data interface between the first user program and the second user program can be easily implemented. This internal data interface can be without latency. This enables fast and reliable communication between the first and second user programs, even in real time.

In a further refinement, the control device has a third interface via which the control device transmits the sensor data and/or the evaluated sensor data of the basic and composite sensors to a device external to the control device. The external device can be a cloud device. The data may be filtered first.

This configuration allows the results of the sensor data analysis to be forwarded to other devices or to the cloud without each smart sensor having to be connected to the external device itself. Information about the evaluated basic and composite sensors can also be provided in an IP-based network. The control device can therefore be configured as a gateway and, if necessary, as a filter and selectively provide both information from the sensor data evaluation and information about the evaluated basic and composite sensors in a network. A possible filter device within the control device can prevent the raw data from the sensors from being transmitted to external devices. This ensures that no sensitive sensor data leaves the company's internal sphere of influence, which in turn improves data sovereignty. The third interface can correspond to the second interface.

In a further refinement, the control device is a safety controller, and the first user program provides safety-related machine control and/or the second user program provides safety-related sensor data evaluation.

A safety controller is a controller with special design of its input components, processing components, and outputs components to ensure the required level of safety and availability when used in safety-critical systems. For safety control, the execution of a user program for machine control must be carried out according to certain criteria and must meet special requirements and normative specifications. The same applies to safety-oriented sensor data evaluation, which is subject to certain normative requirements for safety-critical systems. Changes to the user programs that implement safety-related machine control or safety-related sensor data evaluation are regularly accompanied by the need for recertification. It is therefore desirable to make as few changes as possible to the user programs so that existing user programs can continue to be used. Since the first user program and the second user program can initially be detached and independent of each other, it is possible to continue using existing user programs on the proposed control device without modification. This allows an easy and cost-effective implementation of a safety controller.

In a further refinement, the control device has at least one safety-related equipment that ensures fail-safe evaluation of the basic and composite sensors and/or fail-safe sensor data evaluation.

The control device thus has at least one device that enables it to execute safety-related user programs. This may, for example, involve a redundant design of those components that are responsible for the safety-related execution of the user program, including input and output components. It is also conceivable that another device ensures the safety-oriented design externally.

In a further refinement, the operating system can execute a third user program independently of the first user program and the second user program, which executes a non-safety-related machine control and/or sensor data evaluation.

This design makes it possible to run another user program, for example, in parallel with the first and second user programs. The third user program can be a standard (ST) user program that does not perform any safety-related functions. A consistent separation of safety-related and non-safety-related user programs has the advantage that these components can be developed and certified completely independently of each other.

In a further refinement, the second user program can access the sensor data at will.

Accordingly, the second user program may not be restricted to a specific type of access to the interface. Rather, access can be freely selected by the second user program so that it can receive and provide data as required. The second user program is therefore not dependent on cyclical processing of the sensor data.

In a further refinement, the operating system can establish a connection to a further control device, and the second user program can partially perform the sensor data evaluation on the further control device.

According to this configuration, it is possible for the second user program to cooperate with another control device. This cooperation can include the distributed execution of the second user program on several control devices. Alternatively, the second user program can work together with corresponding user programs on the other control device. In this way, the computationally intensive sensor data evaluation can be distributed over several control devices. This makes it possible to retrofit sensor data evaluation to existing control system networks.

### BRIEF DESCRIPTION OF THE DRAWINGS

Embodiments of the invention are shown in the drawings and are explained in more detail in the following description.

FIG. 1 is a schematic representation of a prior art industrial control system.

FIG. 2 is a schematic representation of an industrial control system with a control device according to an embodiment of the present disclosure.

FIG. 3 is a schematic representation of an internal structure of a control device according to an embodiment of the present disclosure.

FIG. 4 is a schematic representation of an internal structure of a control device according to a further embodiment of the present disclosure.

### DETAILED DESCRIPTION

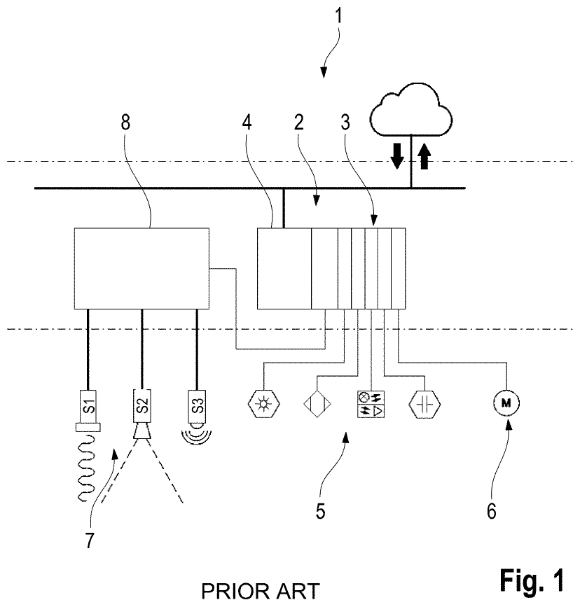

With reference to FIG. 1, a known industrial control system is briefly described in the following. The control system 1 comprises a modular, programmable logic controller (PLC) 2, which has several input and output modules 3 and a central processing unit 4. Basic and composite sensors 5 and actuators 6 are connected to the input and output modules 3. The basic and composite sensors 5 generate input signals depending on the status of a technical system or machine or its environment and transmit the input signals to the input modules. The processing unit 4, which receives the input signals acquired by the input modules, evaluates them, and combines them to generate output signals that are used to control the actuators 6.

In addition, the industrial control system as shown in FIG. 1 comprises so-called smart sensors 7, which independently prepare and process measured variables. Preparation and processing are carried out by an evaluation unit 8, which is separate from the control unit 2 and to which the smart sensors 7 are connected. The evaluation unit 8 uses the results of the evaluation to generate an input signal for the control unit 2. The input signal can be received by the control unit 2, for example, via a further input module. The input signal provided by the evaluation unit 8 corresponds in type to an input signal from a basic or composite sensor and can be processed by the control unit 2 in the same way as a signal from the connected basic and composite sensors 5. In other words, the smart sensors 7 are perceived by the control unit 2 as normal sensors due to the pre-processing by the separate evaluation unit 8. The fact that an input signal comes from a smart sensor 7 is therefore indistinguishable for the control unit 2 in the constellation described. Similarly, the separate evaluation unit 8 does not see the input signals provided by the basic and composite sensors. The smart sensors 7 are therefore decoupled from the actual machine control system by the evaluation unit 8.

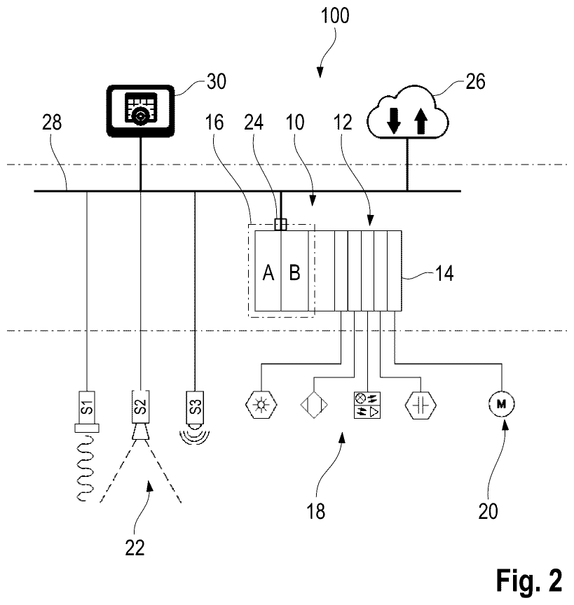

In contrast, FIG. 2 shows an industrial control system with a control device according to an embodiment of the present disclosure. The control system in its entirety is denoted here with the reference numeral 100 and the control device with the reference numeral 10.

The basic structure of the control device 10 corresponds to that of the control device 2 described above. The control device 10 is here also a modular, programmable logic controller with input modules and output modules. As an example, four input modules 12 and one output module 14 are shown here. Furthermore, the control device 10 comprises a processing unit 16 which is coupled to the input and output modules 12, 14 via a bus not shown here. The structure and function of the central processing unit 16 is explained in more detail below. It is understood that the control device 10 is not limited to the configuration shown here but can include further modules and components. Likewise, the control device 10 is not limited to a modular control device but can be any control device that includes an input module, an output module, and a processing unit.

Various basic and composite sensors 18 are connected to the control device 10 via the input modules 12 (first interface). The basic and composite sensors 18 can be coupled to the input modules 12 via digital or analog interfaces (I/Os) or via special fieldbus interfaces provided for I/O communication (e.g. I/O link). The basic and composite sensors 18 are components that are used to measure a physical quantity and convert it into an electrical quantity. Examples of basic sensors are light scanners, proximity sensors, ultrasonic sensors, level sensors, retro-reflective sensors, or similar devices. Composite sensors refer to sensors that are formed from a combination of several basic sensors in one housing and are, for example, light grids or similar devices that are based on a combined measurement of physical variables.

Actuators 20 can be connected to the output modules 14 of the control device 10. The actuators 20 carry out control functions depending on the corresponding output signals. This can be, for example, a motor control as shown here. In various embodiments, the actuator 20 can be a contactor, which is arranged in a power supply of a machine and which de-energizes the machine depending on an output signal from the control device 10. Depending on the output signal can also mean that an action is triggered if the output signal is absent, i.e. the contactor de-energizes if no output signal is present.

The processing unit 16 generates the output signals depending on the input signals. For this purpose, the processing unit 16 executes a first user program A. The first user program A (hereinafter also referred to as the PLC application) usually processes a defined number of instructions cyclically. In a first step, the PLC application can read in a process image of the inputs (PII). The PII reflects the signal states present at the input modules at the time of acquisition. The PLC application is then processed instruction by instruction, whereby the processing device 16 no longer accesses the inputs (input modules) themselves, but only the PII, which is stored in a memory. If outputs (output signal on the output module) are to be changed during processing, this is first done in a special memory area, the so-called process image of the outputs (PIO). The states from the PIO are only passed on to the actual outputs (output modules) after the last instruction from the PLC application. After the output, another cycle begins with the reading in of a new PII.

In contrast to a normal control device, the central processing unit 16 of the proposed control device 10 executes a further user program B (second user program). The second user program B is used to evaluate sensor data. The sensor data can be acquired from smart sensors 22 in this case. Smart sensors 22 are sensors that provide complex sensor data and make it available via special IP interfaces. One example of a smart sensor is a camera system that provides the captured image material in digital form as complex sensor data, e.g. as a continuous data stream. Other smart sensors can be radar systems, for example, which output tuples with various individual values as sensor data in a continuous or discrete data stream or data telegram, whereby the tuple describes a position, a movement, an outer contour, or another property of an object.

In general, the sensor data of smart sensors, which can be several kilobytes or even megabytes in size depending on the sensor type, can be roughly divided into object data, sensor output data, sensor parameters, and configuration and diagnostic data. The sensor data is provided to the control device 10 via a second interface 24. The second interface 24 differs in type from the first interface (input modules). The second interface 24 may be a standardized IP-based interface for establishing a connection to an IP-based network 26. For instance, the second interface 24 can be an OPC-UA (Open Platform Communications Unified Architecture) interface. OPC-UA is a collection of standards for communication and data exchange in the field of industrial automation. OPC-UA can be used to describe the transport of machine-to-machine data as well as interfaces and the semantics of data, whereby the entire architecture is service-oriented.

The second interface 24 can establish a connection to a wired transmission medium or a radio-based transmission medium and can transmit larger amounts of data. Furthermore, the second interface 24 can be a real-time capable interface with defined and guaranteed transmission properties, such as TSN or MQTT.

The sensor data transmitted to the control device 10 is read in and processed by the second user program B. It is possible for the second user program B to record and process sensor data from several sensors. The processing can include the execution of various algorithms, for example algorithms for pattern recognition or image data processing. In addition, data from different sensors can be merged.

The sensor data evaluation can include the generation of 3D point clouds for navigation tasks and forwarding thereof. In various embodiments, the sensor data evaluation can include the detection of objects, the determination of object parameters (size, direction, speed), or object classification. Furthermore, the sensor data evaluation can include dynamic determination of distances between objects and provision of this information for path planning for robot control. It is understood that sensor data evaluation is not limited to these examples but may also involve other data processing methods that can extract application or control-relevant information from sensor data.

For complex and computationally intensive sensor data evaluations, it can be helpful to add computing capacity as required. This makes it possible to distribute complex and computationally intensive data evaluations to several control devices (control heads) in modular control concepts (scalability). Scalability can be further increased by designing the user program for sensor data evaluation in such a way that it can run on controllers of different performance categories.

The results of the sensor data evaluation can be made available to the PLC application or transmitted to other devices via the second interface or another interface. The results of the sensor data evaluation can, for example, contain switch-off information for connected actuators, which is provided to the PLC application as an additional input signal. Therefore, the results of the sensor data evaluation can have a direct influence on the machine control via the PLC application. In addition, the results of the sensor data evaluation can also be transmitted to other devices for further processing or for diagnostic purposes.

The first user program A and the second user program B may be linked to each other via an internal data interface. The internal data interface can be an interprocess/interthread interface or an interface that is realized by shared access to a shared memory area. The results of the sensor data evaluation can be made available to the PLC application via the internal data interface. It is also conceivable that the second user program B, after reading in the sensor data from the second interface 24, makes it available to the PLC application as raw data.

Conversely, it is possible for the second user program B to access data from the basic and composite sensors 18 in order to take them into account in the sensor data evaluation. The latter enables the data from the smart sensors 22 to be merged with the data from the base and composite sensors 18, which can also be used to forward the data from the base and composite sensors 18 to other devices or the cloud 26. Therefore, basic and composite sensors 18, which do not usually have their own IP interface, can also provide their data in an IP-based network 28.

The smart sensors 22 may also send their data directly to other devices for further evaluation via the IP-based network 28. For example, computationally intensive algorithms, such as those required for machine learning to extract further information from the sensor data, can be executed in the cloud 26. Accordingly, evaluations that are not subject to real-time requirements can be executed in the cloud 26 or on other devices. It is also conceivable that data from the smart sensors 22 can be selectively processed by external devices and by the control device 10. This makes it possible to send only non-sensitive sensor data to external devices, while sensitive sensor data is processed internally by the control device 10 (data sovereignty).

In addition to the smart sensors 22 and the control device 10 including the basic and composite sensors 18, configuration and diagnostic devices 30 can also be connected to the IP-based network 28. The smart sensors 22 can communicate directly with these devices. In addition, the control device 10 equipped with the second interface 24 enables the basic and composite sensors 18 to provide diagnostic and/or configuration information. This helps to improve the uniform and holistic configuration and diagnosis of the control system 100.

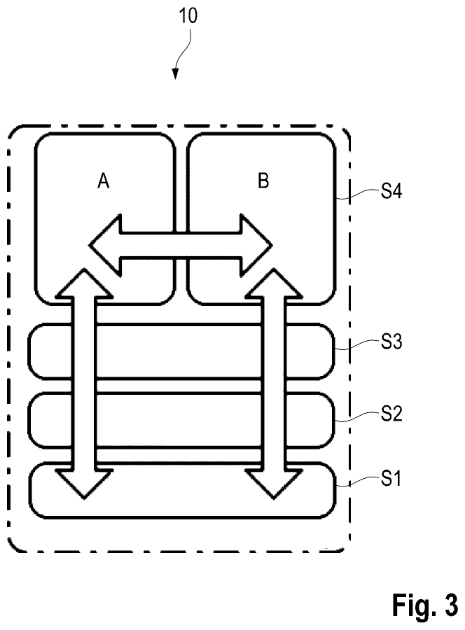

FIG. 3 shows a schematic representation of the internal structure of a control device 10 according to an embodiment of the present invention. The internal structure is shown here as a layer model in which individual aspects of the architecture of the control device 10 are conceptually assigned to a layer.

The lowest layer S1 comprises the interfaces via which the control device 10 is connected to external devices and the peripherals. This includes the input modules (first interface), the output modules and an IP-based interface (second interface). Via these interfaces, the control device 10 receives data from the connected sensors, which include both the basic and composite sensors 18 and the smart sensors 22.

The second layer S2 comprises the physical processing units and is essentially made up of central processing units (processors) and system resources (memory, etc.). The processing units can be multicore processors or multicore microcontrollers, which enable parallel execution of processes and threads and thus promote the concurrency of programs. This layer also includes any safety-related equipment that can ensure fail-safety of the safety control system. The safety-related equipment can include redundancy and diversity facilities.

The third layer S3 forms the operating system of the control device 10. The operating system consists of a variety of programs that enable the loading, execution, interruption and termination of user programs, the management and allocation of processor time and the allocation and management of memory space. In addition, the operating system can contain hardware drivers that enable user programs to access hardware components. In the case of a safety controller, the operating system may also have additional features that can ensure fail-safety. For a control device 10 according to the present disclosure, the operating system is at least configured to execute two user programs of different types, wherein the operating system can execute the two user programs in parallel.

The top layer S4 is formed by the user programs, which have at least one user program A for machine control and one user program B for sensor data evaluation. The first user program A is a PLC program that sequentially executes a series of instructions one after the other, wherein a first instruction in the cycle comprises reading inputs and the last instruction in the cycle comprises outputting to the outputs. The second user program B, on the other hand, can process sensor data cyclically or continuously. The second user program B may have random access to the second interface, via which it can receive data from sensors. Random access is to be understood that the user program B can request data from the second interface at any time. The user program B is therefore not limited to a specific processing of the sensor data. For instance, the second user program B can provide a continuous output of evaluation results or raw data. The sensor data evaluation itself can include various algorithms depending on the type of sensor connected in order to extract application or control-relevant information from the sensor data.

The operating system may execute the first user program A and the second user program B in parallel. Furthermore, the operating system can provide an internal interface (indicated here by the transverse double arrow) via which the first user program A can exchange data with the second user program B, essentially without latency. It is also conceivable that data is only exchanged in one direction, e.g. data is only transferred from user program A to user program B or vice versa. In this way, the independence of at least one user program can be achieved. In addition, the operating system is responsible for ensuring data exchange between the user programs and the respective interfaces, as indicated here by the vertical arrows.

The operating system is not limited to a specific type of operating system as long as it can execute at least two user programs and enable the data flow to the interfaces shown. The operating system may be a real-time operating system (RTOS) or has facilities that enable the execution of a user program in real time or near real time. In this context, real time means that the operating system can reliably and deterministically process requests from a user program or the arrival of signals via the interfaces within a predetermined period of time.

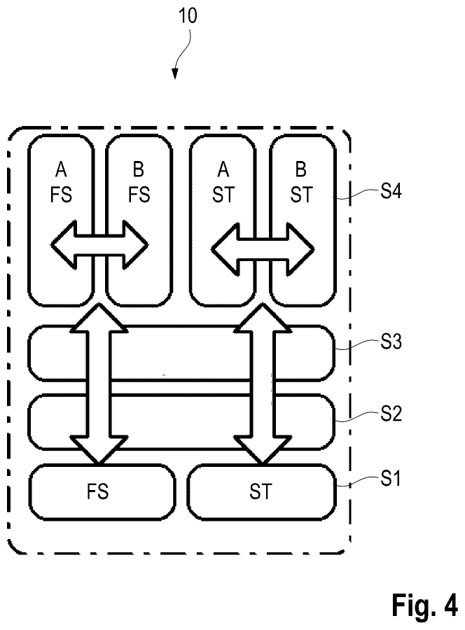

FIG. 4 shows a schematic representation of an internal structure of a control device 10 according to a further embodiment of the present disclosure. The structure shown is based on the layer model as described with reference to FIG. 3.

In contrast to the structure shown in FIG. 3, both the interfaces and user programs are divided into safety-related and non-safety-related user programs or interfaces in order to establish a defined independence of these components from each other. The separation allows the control device to efficiently perform both standard functions ST (Standard) and safety-related functions FS (Fail-Safe). While in principle standard ST functions can also be performed by a fail-safe FS control system, the isolation can avoid any interferences between different data and evaluation procedures from a functional safety point of view. The same applies to the interfaces, which should also be implemented separately. Otherwise, layers S2 and S3 are unchanged, as they should be uniformly configured for a safety-oriented application.

According to the configuration of FIG. 4, both user programs A for machine control and user programs B for sensor data evaluation are provided as FS user programs and as ST user programs. In other words, an FS and an ST variant can be provided for each type of user program. It goes without saying that not all variants must always be available. The same applies to the interfaces each including an FS interface and an ST interface. It is also conceivable that only one FS interface is available. However, the consistent separation of FS and ST elements has the advantage that the FS components can be completely independent of the ST components. This principle is also reflected in the internal data interfaces between the user programs shown here. Again, there should be no connection between FS user programs and ST user programs.

A control device according to FIG. 4 can be realized flexibly and easily, which includes both safety-critical control functions and normal control functions.

The embodiments disclosed above are various embodiments of the invention. It is understood that individual features of the various embodiments can be used in the other embodiments. In principle, the invention is not limited by the embodiments shown here but is defined solely by the following claims.

The phrase at least one of A, B, and C should be construed to mean a logical (A OR B OR C), using a non-exclusive logical OR, and should not be construed to mean “at least one of A, at least one of B, and at least one of C.”

What is claimed is:

1. A control device for machine control and sensor data evaluation, the control device comprising:
a first interface to basic and composite sensors for machine control;
a second interface to sensors for sensor data evaluation;
a central processing unit; and
an operating system for executing user programs using the central processing unit, wherein:
the user programs include at least a first user program and a second user program,
the first user program is a user program for machine control that executes a control function on the basis of an evaluation of the basic and composite sensors, and
the second user program is a user program for sensor data evaluation that evaluates sensor data received via the second interface.

2. The control device of claim 1 wherein the second user program is configured to make the evaluated sensor data available to the first user program.

3. The control device of claim 1 wherein the first user program is configured to use the evaluated sensor data for machine control.

4. The control device of claim 1 wherein the operating system is configured to execute the first user program and the second user program in parallel with each other.

5. The control device of claim 1 wherein the first interface is an interface for input/output (I/O) communication via a fieldbus.

6. The control device of claim 5 wherein the first interface is a standardized IO-Link interface.

7. The control device of claim 1 wherein the first interface is a module of the control device and is coupled to the central processing unit via an internal bus connection.

8. The control device of claim 1 wherein the second interface is a real-time capable interface.

9. The control device of claim 1 wherein the second interface is a standardized IP-based interface.

10. The control device of claim 9 wherein the second interface is an Open Platform Communications Unified Architecture (OPC-UA) interface.

11. The control device of claim 1 wherein the second interface is at least one of a wired or a wireless interface.

12. The control device of claim 1 further comprising an internal data interface, wherein the first user program and the second user program are connected to each other via the internal data interface.

13. The control device of claim 1 further comprising a working memory, wherein the operating system is configured to allocate a common memory area within the working memory to the first user program and the second user program.

14. The control device of claim 1 further comprising a third interface, wherein the third interface is configured to transmit at least one of the sensor data and the evaluated sensor data of the basic and composite sensors to a device external to the control device.

15. The control device of claim 14 wherein the device external to the control device is a cloud device.

16. The control device of claim 14 wherein the third interface is configured to filter at least one of the sensor data or the evaluated sensor data before transmission.

17. The control device of claim 1 wherein the control device is a safety controller and the first user program provides safety-related machine control.

18. The control device of claim 1 wherein the control device is a safety controller and the second user program provides safety-related sensor data evaluation.

19. The control device of claim 1 wherein the control device has at least one safety-related equipment that ensures at least one of:
a fail-safe evaluation of the basic and composite sensors, or
a fail-safe sensor data evaluation.

20. The control device of claim 1 wherein the operating system is further configured to execute a third user program independently of the first user program and the second user program, the third user program executing at least one of a non-safety-related machine control or a non-safety-related sensor data evaluation.

21. The control device of claim 1 wherein the second user program is configured to access the sensor data at random.

22. The control device of claim 1 wherein:
the operating system is configured to establish a connection to a further control device, and
the sensor data evaluation is being partially executed by the second user program on the further control device.
